(19) United States
(12) Patent Application Publication
(10) Pub. No.: US 2009/0111697 A1
(43) Pub. Date: Apr. 30, 2009

(54) PROPIONIC ACID AS AN HERBICIDE

(75) Inventors: Brian Campbell, Davis, CA (US); Lorena Fernandez, Sacramento, CA (US); Marja Koivunen, Davis, CA (US); Pamela Marrone, Davis, CA (US)

Correspondence Address: CHERYL H AGRIS PHD, PO BOX 806, PELHAM, NY, 10803, US

(73) Assignee: Marrone Organic Innovations, Davis, CA (US)

(21) Appl. No.: 12/257,472

(22) Filed: Oct. 24, 2008

Related U.S. Application Data
(60) Provisional application No. 60/983,157, filed on Oct. 26, 2007.

(51) Int. Cl. A01N 37/02; A01P 13/00

(52) U.S. Cl. 504/320

(57) ABSTRACT

The present invention discloses that, propionic acid or salt thereof, is an effective pre-emergent and post-emergent herbicide. Propionic acid biodegrades first to acetic and formic acids and then to carbon dioxide and water thus posing not threat the environment. Propionic acid is less caustic and corrosive than formic acid, and with proper formulation and the use of respiratory protection, it poses no threat to the applicator. Propionic acid is demonstrated in this invention to control both monocotyledonous and dicotyledonous plants.

### PRIORITY CLAIM

This application claims priority to application Ser. No. 60/983,157 on Oct. 26, 2007, the contents of which are incorporated herein by reference.

### FIELD OF THE INVENTION

This invention relates to compositions and methods for controlling weeds using compounds comprising formic acid or salt thereof as an active ingredient.

### BACKGROUND OF THE INVENTION

Weeds cause up to 12% loss in crop yields in the United States each year costing nearly $33 billion dollars (Pimentel, D., McNair, S., Janecka, J., Wightman, J., Simmonds, C., O'Connell, C., Wong, E., Russel, L., Zern, J., Aquino, T., Tsomondo, T. 2001. Economic and environmental threats of alien plant, animal, and microbe invations. Agriculture Ecosystems & Environment 84: 1-20). Farmers have to rely mainly on synthetic herbicides to reduce these losses and spend $6.1 billion dollars each year to control weeds. In 1998, herbicides accounted for 68% of total U.S. pesticide sales. Many herbicidal products contain glyophosate (see, for example, U.S. Pat. No. 6,200,929).

There are two general categories of herbicides: pre-emergence and post-emergence. Organic growers have discovered that corn gluten meal (a by-product in the manufacture of cornstarch) can serve as an effective pre-emergence herbicide. Since corn gluten meal affects only sprouting seeds, it is safe to use around mature or established plants. Herbicidal “soaps” serve as organic post-emergence herbicides. These products contain fatty acid salts that break down into carbon dioxide and water. A commercially available fatty acid (pelargonic acid) is sold under the trade name Scythe™.

Propionic acid, also known as propanoic, methylacetic or ethanecarboxylic acid (CAS 79-09-4), is a saturated, aliphatic monocarboxylic acid, used as an esterifying agent, in the production of calcium and sodium propionates, as an intermediate for cellulose propionate thermoplastics, and in the synthesis of herbicides, pharmaceuticals and perfumes (Guest, D., Katz, G. V., Astill. B. D., 1982. Aliphatic Carboxylic Acids. In: Patty's Industrial Hygiene and Toxicology. (Clayton, G. D. and Clayton, F. E., Eds.). Third revised edition. pp. 4901-4980. John Wiley & Sons, New York, N.Y.). Propionic acid is a normal intermediary metabolite formed in the oxidation of odd-number carbon fatty-acids and from the side chain of cholesterol. It is a moderate skin irritant, but generally recognized as safe for use as a chemical preservative in human food (21 CFR 182.3081) as well as in animal feed (21 CFR 582.3081). Propionic acid has higher boiling point and lower specific gravity than formic acid, and it is less corrosive and caustic than formic or acetic acid (Guest, D., Katz, G. V., Astill. B. D., 1982. Aliphatic Carboxylic Acids. In: Patty's Industrial Hygiene and Toxicology, Clayton, G. D. and Clayton, F. E., Eds., Third revised edition. pp. 4901-4980, John Wiley & Sons, New York, N.Y.).

### SUMMARY OF THE INVENTION

The present invention discloses the use of propionic acid as a pre-emergent and post-emergent herbicide, particularly the use of propionic acid for the preparation of a composition for herbicidal use, either as a pre-emergent or post-emergent pesticide. In a particular embodiment, propionic acid is used as a pre-emergent pesticide and is applied to the soil. It can serve as a safer alternative to synthetic herbicides now on the market. Thus, the invention is directed to a method for modulating emergence of monocotyledonous or dicotyledonous weeds comprising applying to said weeds in soil an amount of propionic acid effective to modulate emergence of monocotyledonous or dicotyledonous weeds in soil. Alternatively, the invention is directed to a method for modulating emergence of monocotyledonous or dicotyledonous weeds in soil comprising applying to said soil an amount of propionic acid effective to modulate emergence of monocotyledonous or dicotyledonous weeds in said soil.

Furthermore, the invention is directed to a composition comprising propionic acid and/or one or more propionic acid salts present in an herbicidally effective amount and a carrier and/or diluent, which is essentially free of fatty acid present in an herbicidally effective amount as well as a method for modulating emergence of monocotyledonous or dicotyledonous weeds in soil comprising applying to said weeds and/or said soil an amount of said composition effective to modulate emergence of monocotyledonous or dicotyledonous weeds in soil. In a particular embodiment, the invention is directed to a polyphenol-free, herbicidal composition comprising (a) propionic acid and/or one or more propionic acid salts in herbicidally effective amounts and (b) a carrier and/or diluent, wherein said composition is free of an amine containing surfactant and is optionally free of fatty acid in an herbicidally effective amount as well as a method for modulating emergence of monocotyledonous or dicotyledonous weeds in soil comprising applying to said weeds and/or said soil an amount of said composition effective to modulate emergence of monocotyledonous or dicotyledonous weeds in soil. In a preferred embodiment, the composition is in solid form, particularly in the form of a solid granule. Alternatively, the invention encompasses a polyphenol-free, glyphosate-free, amine-containing surfactant free, fatty acid free herbicidal composition comprising (a) at least one of (i) propionic acid or (ii) one or more propionic acid salts, wherein said propionic acid or propionic acid salt is present in herbicidally effective amounts and (b) at least one of (i) a carrier or (ii) diluent.

In a particular embodiment, the composition comprises (a) propionic acid and/or (b) one or more propionic acid salts, (c) one or more essential oils and (d) carrier and/or diluent, as well as a method for modulating emergence of monocotyledonous or dicotyledonous weeds in soil comprising applying to said weeds in soil an amount of said composition effective to modulate emergence of said weeds in said soil. Alternatively, the method for modulating emergence of monocotyledonous or dicotyledonous weeds may comprise applying first the propionic acid or its salt to said weeds and/or said soil and then applying one or more essential oils or vice versa or alternatively concurrently wherein said propionic acid and said essential oil(s) are applied in herbicidally effective amounts.

In another particular embodiment, the invention is directed to an herbicidal composition comprising propionic acid present in an herbicidally effective amount and a carrier and/or diluent, wherein said composition is free of fatty acid in an herbicidally effective amount.

In yet another particular embodiment, the invention is directed to an herbicidal composition comprising (a) at least one of: (i) propionic acid or (ii) one or more propionic acid salts, (b) hinokitiol, and (c) at least one of (i) a carrier or (ii) diluent.

The composition may further comprise a second herbicidal agent. These include but are not limited to chemical herbicides such as paraquat and glyphosate as well as organic herbicides containing plant extracts and essential oils.

In the method of the present invention, compositions applied to the soil are used as pre-emergent herbicides and may be in solid form. In a particular embodiment, they may be dissolved in a diluent.

### OBJECTS OF THE INVENTION

A primary object of the invention is to provide pre- and post-emergence herbicidal compositions and in particular solid pre-emergent herbicidal compositions that contain propionic acid as an active ingredient.

Another object is to provide a safe, non-toxic herbicidal composition and a method that will not harm the environment.

It is still another object to provide an herbicidal composition to which plants can not develop resistance.

The above and other objects are accomplished by the present invention which is directed to herbicidal compositions containing propionic acid with certain carriers to control germination of weed seeds in soil and other growth media. In addition, the present invention is directed to a method for post-emergence control of broadleaved and grass weeds using an herbicidal composition containing propionic acid as an active ingredient.

### BRIEF DESCRIPTION OF THE FIGURES

FIG. 1 shows the efficacy of propionic acid sprayed on annual bluegrass at various concentrations.

FIG. 2 shows the phytotoxic effect of propionic acid sprayed on annual bluegrass at concentrations 2-10%.

FIG. 3 presents the effect of two herbicidal formulations containing hinokitiol and propionic acid on annual bluegrass (P. annua).

### DETAILED DESCRIPTION OF THE INVENTION

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a,” “and” and “the” include plural references unless the context clearly dictates otherwise.

The present invention discloses the use of propionic acid as a pre- and post-emergence herbicide. It can serve as a safer alternative to synthetic herbicides now on the market.

In one embodiment, the present invention provides an herbicidal composition comprising, in admixture with a suitable carrier and optionally with a suitable surface active ingredient, propionic acid or propionic acid salt at concentrations between 0.001-95% by weight, or more particularly, about 5-30% by weight. The propionic acid salt may be an organic alkali metal salt selected from the group consisting of sodium and potassium. The composition of the present invention may comprise propionic acid and/or one or more propionic acid salts. In a particular embodiment, the propionic acid salt is a monopropionate alkali metal salt, in particular, sodium monopropionate or potassium monopropionate.

The compositions of the present invention may be sprayed on the plant or applied to the soil. Particular embodiments are described in the Examples, infra. These compositions may be in the form of dust, coarse dust, micro granules, granules, wettable powder, emulsifiable concentrate, liquid preparation, suspension concentrate, water degradable granules or oil suspension. In a specific embodiment, the compositions are in solid form in the form of a granule.

The compositions of the invention do comprise a carrier and/or diluent. The term, ‘carrier’ as used herein means an inert, organic or inorganic material, with which the active ingredient is mixed or formulated to facilitate its application to the soil, seed, plant or other object to be treated, or its storage, transport and/or handling. The carrier used will depend on whether it is being used in a pre- or post-emergence herbicide. Liquid carriers can be used for both pre and post-emergence applications. Examples of carrier vehicles for the pre-emergence herbicide include, but are not limited to, active charcoal, corn gluten meal, soybean meal, vermiculite, bentonite, kaolinite, wheat germ, almond hulls, cottonseed meal, Fuller's earth, orange pulp, rice hulls, sawdust, Gum arabic, etc. If desired, plant essential oils such as cinnamon, clove, thyme (eugenol as active ingredient), wintergreen, citronella and pine oil, lemongrass and the like, as well as other natural compounds like hinokitiol (B-thujaplicin) can be included in the mixture to improve the pre-emergence and post-emergence effect of propionic acid. Examples of diluents or carriers for the post-emergence herbicides include, but are not limited to, water, milk, ethanol, mineral oil, glycerol, and other organic acids such as acetic, formic and citric acid.

The composition may additionally comprise a surfactant to be used for the purpose of emulsification, dispersion, wetting, spreading, integration, disintegration control, stabilization of active ingredients, improvement of fluidity or rust inhibition. The choice of dispersing and emulsifying agents, such as non-ionic, anionic, amphoteric and cationic dispersing and emulsifying agents, and the amount employed is determined by the nature of the composition and the ability of the agent to facilitate the dispersion of the herbicidal compositions of the present invention. In a particular embodiment, the composition is free of an amine containing surfactant.

For pre-emergence dry formulations, the granule size of the carrier is typically 1-2 mm (diameter) but the granules can be either smaller or larger depending on the required ground coverage. Granules may comprise of porous or non-porous particles, and they generally contain 0.05-40%, preferably 5-25% propionic acid and/or propionic acid salt.

For post-emergent formulations, the formulation components used may contain smectite clays, attapulgite clays and similar swelling clays, thickeners such as xanthan gums, gum Arabic and other polysaccharide thickeners as well as dispersion stabilizers such as nonionic surfactants (for example polyoxyethylene (20) monolaurate). The concentration of the clays may vary between 0-2.5% w/w of the total formulation, the polysaccharide thickeners may range between 0-0.5% w/w of the total formulation and the surfactants may range between 0-5% w/w of the total formulation.

In commercial and agricultural applications, the present invention encompasses carrier composition mixture in which the herbicidal compositions are present in an amount between about 0.01-95% by weight, and preferably 0.5-90% by weight, and even more preferably 5-30% by weight of the mixture. Specific embodiments of the formulation of the present invention are described below:

| Propionic Acid Composition | (% w/w) |
|---|---|
| Component 1 Propionic Acid | 0.001-99.5 |
| Component 2 Water | 0.5-99.999 |

| Propionic Acid in | |
|---|---|
| combination with Natural | |
| herbicide (e.g. essential oil) | |
| Surfactant System | (% w/w) |
| Component 1 Propionic Acid | 10-88% |
| Component 2 Herbicide surfactant | 2-50% |
| Component 3 Surfactant system | 10-40% |

| Propionic Acid in | |
|---|---|
| combination with | |
| Synthetic herbicide | |
| (e.g. Glyphosate) | (% w/w) |
| Component 1 Propionic Acid | 50-93 |
| Component 2 Synthetic Herbicide | 2-20 |
| Component 3 Surfactant System | 5-30 |

| Propionic Acid in | |
|---|---|
| combination with Synthetic | |
| Herbicidal Adjuvant | |
| (e.g. Octylphenols) | (% w/w) |
| Component 1 Propionic Acid | 60-90 |
| Component 2 Herbicidal Adjuvant | 5-20 |
| Component 3 Surfactant system | 5-20 |

Examples of surfactant systems include but are not limited to ethoxylated alcohols, ethoxylated fatty esters, ethoxylated castor oil, alkoxylated glycols, ethoxylated fatty acids, carboxylated alcohols, carboxylic acids, fatty acids, ethoxlylated alkylphenols, fatty esters, lignins, blocked copolymers, EO/PO copolymers. Examples of anionic surfactants include but are not limited to the following examples: EPA list 4A soaps (anionic surfactants): sodium lauryl sulfate, Octadecanoic acid, ammonium salt, 9-Octadecenoic acid (9Z)-, potassium salt. The surfactant system may contain a single surfactant or combination of surfactants as necessary to develop the optimum formulation.

The composition and method of the present invention will be further illustrated in the following, non-limiting Examples. The examples are illustrative of various embodiments only and do not limit the claimed invention regarding the materials, conditions, weight ratios, process parameters and the like recited herein.

### EXAMPLES

### Example 1

The phytotoxic effects of propionic and formic acids were tested on germinating dicot seeds. A single seed of Lactuca sativa (lettuce) was placed in each well of a 96-well plate followed by a 75-ul aliquot of each solution in a stepwise (1:2) dilution series with DI water from 5% to 0%. DI water was used as a control. The plate was sealed with a plastic cover, and placed under greenhouse lights (12 hr light/dark cycle) for 11 days after which the germination at each concentration was recorded. See the results below. Germinated seed was marked as “+” and seed which failed to germinate was marked as “−”. The design of the study is shown in Table 1.

TABLE 1

| | 5.00% | 2.50% | 1.25% | 0.75% | 0.36% | 0.19% | 0.09% | 0.05% | 0.02% | 0.01% | 0.005% | Control |
|---|---|---|---|---|---|---|---|---|---|---|---|---|
| | 1 | 2 | 3 | 4 | 5 | 6 | 7 | 8 | 9 | 10 | 11 | 12 |
| Propionic Acid 5 | − | − | − | − | − | − | − | − | + | + | + | + |
| (% v/v) | | | | | | | | | | | | |
| Propionic Acid 5 | − | − | − | − | − | − | − | − | − | + | + | + |
| (% v/v) | | | | | | | | | | | | |
| Propionic Acid 5 | − | − | − | − | − | − | − | + | + | + | + | + |
| (% v/v) | | | | | | | | | | | | |
| Control D | + | + | + | + | + | + | + | − | + | + | + | + |
| Control E | + | + | + | + | + | + | − | + | + | + | + | + |
| Formic Acid 5 (% v/v) | − | − | − | − | − | − | − | − | + | + | + | + |
| Formic Acid 5 (% v/v) | − | − | − | − | − | − | − | + | − | + | + | + |
| Formic Acid 5 (% v/v) | − | − | − | − | − | − | − | − | − | − | + | + |

Based on this screening study, propionic acid is as effective as formic acid in controlling the germination of dicot weed seeds. The threshold value for complete inhibition of seed germination was determined at 0.09%.

### Example 2

A high-throughput 96-well assay was used to test the efficacy of propionic acid as a post-emergence, non-selective herbicide. Seedlings of Lactuca sativa (lettuce) were grown in water agar in 96-well plates under continuous light. Propionic acid was added on the seedlings at a 2×-dilution series from 20% to 0%, and the minimum concentration needed for killing the seedling was recorded the next day. According to the results, propionic acid at a concentration of 0.156% was able to kill the lettuce seedling, whereas propionic acid at a concentration of 0.08% was not harmful for the plant.

### Example 3

### Procedure:

To further test the inhibitory effect of propionic acid on germinating seeds, pots with 6-cm diameter were filled with 60 mL of silty clay loam soil passed through a 2-mm sieve, and five (5) seeds of either Lactuca sativa (lettuce, representing a broadleaf plant) or Poa annua (annual bluegrass, representing a grass weed) were planted on the top. A solid form of the composition containing corn gluten meal granules (1-2 mm diameter) soaked in 0%, 10%, 15% or 20% propionic acid solution and dried were placed on the top of the soil at rates 0.1, 0.25, and 0.5 g/pot. The pots were kept at optimum water content under growth lights with a 12-h light/dark period at room temperature, and the number of germinated seeds was counted after one week. The results were reported as a percent of weed seeds germinated relative to the control treatment with no corn gluten meal added. The results are presented in Table 2 below.

TABLE 2
Germination % (relative to untreated control) of lettuce and annual
bluegrass at various rates of propionic acid imbedded in
corn gluten meal

germination rate (%)

| Propionic | rate | | annual |
|---|---|---|---|
| acid % | g/pot | lettuce | bluegrass |
| 0 | 0.1 | 100 | 89 |
| | 0.25 | 75 | 30 |
| | 0.5 | 25 | 15 |
| 10 | 0.1 | 50 | 37 |
| | 0.25 | 75 | 44 |
| | 0.5 | 42 | 22 |
| 15 | 0.1 | 83 | 44 |
| | 0.25 | 25 | 52 |
| | 0.5 | 42 | 30 |
| 20 | 0.1 | 42 | 44 |
| | 0.25 | 67 | 37 |
| | 0.5 | 33 | 96 |

Conclusion:
The pre-emergence effect did not depend on the concentration of propionic acid in the granules. Propionic acid increased the pre-emergence herbicidal effect only at the lowest application rate (0.1 g/pot corresponding to 360 lbs/acre).

### Example 4

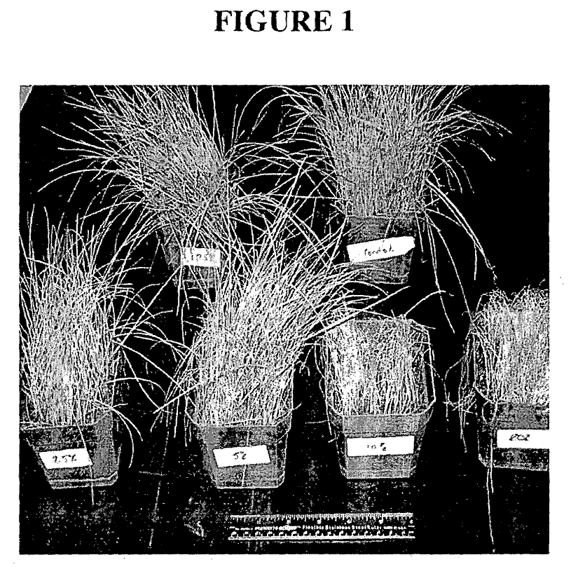

Pots with 6-cm diameter were filled with potting mix, and about thirty (30) seeds of Poa annua (annual bluegrass, representing a grass weed) were planted on the top. The seeds were germinated and the plants grown at optimum water content under growth lights with a 12-h light/dark period at room temperature until they were about 3 inches tall. To test the post-emergence effect of propionic acid, the plants were sprayed with 2 mL of water solutions containing increasing concentrations of propionic acid. The following concentrations (v/v %) were used: 0% (control), 0.5% 2.5%, 5%, 10%, and 20%. the plants were observed four days after the treatment. According to visual observations (FIG. 1), the lowest concentration (0.5%) had no herbicidal effect. Plants treated with the two highest rates (10% and 20%) showed symptoms of wilting, scorching and eventually, death.

### Example 5

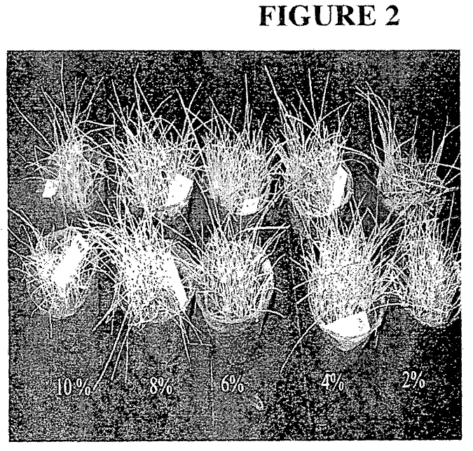

To further test the minimum concentration of propionic acid required to control Poa annua (as an example of a grass weed) another study was set up in small peat pots using concentrations 0% (control), 2%, 4%, 6%, 8% and 10% of propionic acid. Each treatment was carried out in replicates, and the results are presented in FIG. 2. According to the results, a concentration of 8-10% is needed for good control.

### Example 6

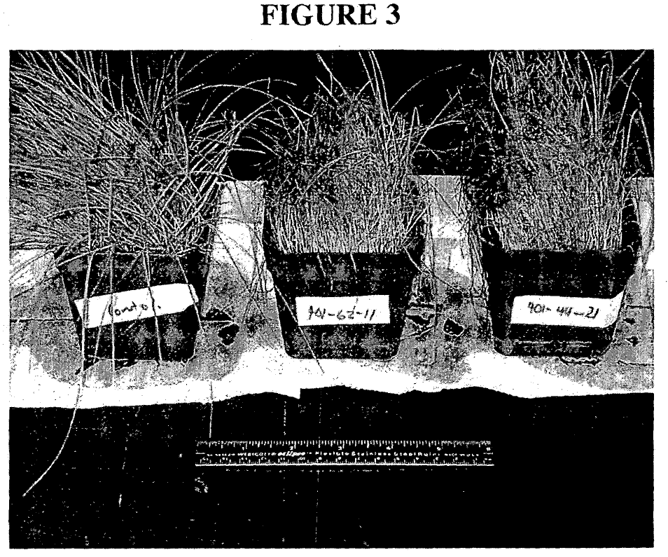

Two formulations (below) with hinokitiol (β-thujaplicin) dissolved in either reagent alcohol (410-44-21) or propionic acid (401-62-11) were applied on annual bluegrass (Poa annua) established in a pot. An aliquot of 25 mL of formulation was sprayed in each pot, and the pots were incubated under growth lamps at 12-hr dark/light cycle for 4 days after which the plants were observed for phytotoxicity symptoms (scorching and drying of leaves). Plants in the control plot were treated with DI water. Both tested formulations resulted in severe scorching of plants indicating high phytotoxicity (FIG. 3).

| Formulation 410-44-21 | % |
|---|---|
| Propionic acid | 20 |
| Hinokitiol (33% in Reagent Alcohol) | 30 |
| Essential oil (such as lemongrass, cinnamon) | 20 |
| Glycerol esters | 30 |
| Total | 100 |

| Formulation 401-62-11 | % |
|---|---|
| Hinokitiol (60% in Propionic Acid) | 80 |
| Glycerol esters | 17.5 |
| Ethoxylated alcohol (such as castor oil) | 1.25 |
| Soy methyl ester | 1.25 |
| Total | 100 |

The solubility of hinokitiol in proprionic acid was 60% w/w or 3 parts hinokitiol to 2 parts propionic acid by weight, under ambient conditions. Under the correct conditions the solubility of hinokitiol in propionic acid would exceed 3 parts hinokitiol to 2 parts propionic acid, by weight. Under ambient conditions, the maximum solubility of hinokitiol in ethanol is 50% w/w or 1 part hinokitiol to 1 part ethanol by weight.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

Various references are cited herein, the disclosures of which are incorporated by reference in their entireties.

What is claimed is:

1. A polyphenol-free, glyphosate-free, amine-containing surfactant free, fatty acid free herbicidal composition comprising (a) at least one of (i) propionic acid or (ii) one or more propionic acid salts, wherein said propionic acid or propionic acid salt is present in herbicidally effective amounts and (b) at least one of (i) a carrier or (ii) diluent.

1. The composition according to claim 1, wherein said composition comprises propionic acid.

2. The composition comprising claim 1, wherein said composition comprises propionic acid salt.

3. The composition according to claim 1, wherein said composition comprises propionic acid and a propionic acid salt.

4. The composition according to claim 3, wherein said propionic acid salt is an alkaline metal salt.

5. The composition according to claim 3, wherein said composition is a propionic acid salt is a monopropionate salt.

6. The composition according to claim 5, wherein said propionic acid salt is an alkaline metal salt selected from the group consisting of potassium and sodium.

8. The composition according to claim 1 wherein said composition further comprises an essential oil.

9. The composition according to claim 8, wherein said essential oil is selected from the group consisting of cinnamon, clove, thyme, wintergreen, citronella and pine oil and lemongrass oil

10. The composition according to claim 1, further comprising a second herbicidal agent.

11. The composition according to claim 1, wherein said composition is in solid form.

12. The composition according to claim 1, wherein said composition is in liquid form.

13. An herbicidal composition comprising propionic acid present in an herbicidally effective amount and a carrier and/or diluent, wherein said composition is free of fatty acid in an herbicidally effective amount.

14. An herbicidal composition comprising (a) at least one of: (i) propionic acid or (ii) one or more propionic acid salts, (b) hinokitiol, and (c) at least one of (i) a carrier or (ii) diluent.
